(19) United States
(12) Patent Application Publication
(10) Pub. No.: US 2010/0217963 A1
(43) Pub. Date: Aug. 26, 2010

(54) System, method and computer-readable medium for providing and executing a sequence of launch of applications at boot-up

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 12/380,406

(22) Filed: Feb. 25, 2009

(51) Int. Cl. G06F 9/00

(52) U.S. Cl. 713/2; 713/1

(57) ABSTRACT

Methods, systems and computer-readable medium for enabling a user to direct a computational device to store a desired sequence of launch of software applications stored within, or accessible to, the computational device are provided. The user may direct the computational device to initiate a boot-up of an operating system of the computational device while integrating a launch of software applications as instructed by the stored sequence of launch. The computational device may be enabled for communication with an electronic communications network, e.g., the Internet or a telephony system, and at least software application may be downloaded from the electronic communications network. The additional application may be downloaded from a server upon direction of an OEM, marketer or other member of the stream commerce from which the computer was acquired or provided.

### FIELD OF THE INVENTION

The present invention relates to the field of computational devices and particularly to a method and system for implementing user-specified sequential actions and processes during boot-up.

### BACKGROUND OF THE INVENTION

The ubiquity of computational devices has motivated the software industry to provide a myriad of software applications that may each be of specific interest to a portion of the user community of one or more distinguishable devices. This population of software applications increases the desire and expectation of many users to personalize the content of a computational device, such as an cellular telephone, a personal computer, a personal digital assistant, or other software-configurable computational devices.

A resident operating system is typically booted up in a of most electronic computational devices boot-up process when switching on an electrical power input to the device. In the prior art, a fundamental boot-up information applicable to the hosting electronic computational device along with the operating system may stored in a non-volatile read only memory. Common read only memories of electronic computational devices are typically realized by semiconductor memory devices. Each semiconductor memory device comprises several memory units, which are arranged in at least one memory matrix. The memory units comprise semiconductor components, which are built invariably into the memory matrix corresponding to the hardwired programming of the read only memory. The semiconductor components are located on semiconductor chips and can be manufactured with generally known semiconductor fabrication techniques.

Electronic communications devices that enable communication with the Internet or a telephony system typically further comprise random access memory and optionally disc based memory within which software encoded instructions and information may be added to, deleted from, and/or overwritten. This rewriteable memory may allow a user to upload and download the software applications that make the hosting device more valuable to and convenient for the user. Yet the thousands of software applications that may be of interest to various unique users create the potential of processing overload, or degradation of service, of certain electronic computational devices.

There is therefore a long felt need to enable a user to configure an electronic computational device with user selected software and to modify the boot-up process to better address the preferences of the user.

### SUMMARY OF THE INVENTION

This and other objects of the present invention are made obvious in light of this disclosure, wherein methods, systems and computer-readable media for enabling a user to direct a computational device to store a desired sequence of launch of software applications stored within, or accessible to, the computational device. The user may thereafter direct the computational device to initiate a boot-up of an operating system of the computational device while integrating a launch of software applications as per the stored sequence of launch.

In another optional aspect of the method of the present invention, the computational device, or “computer”, may be enabled for communication with an electronic communications network, e.g., the Internet or a telephony system, and at least software application is downloaded from the electronic communications network.

In yet another optional aspect of the method of the present invention the additional application may be downloaded through an electronics communications network from a server and as directed by a member or agent related to the stream commerce from which the computer was acquired or provided.

In still another optional aspect of the method of the present invention a computer is provided that enables a user to direct the execution of one or more aspects of the method of the present invention.

In still another optional aspect of the method of the present invention a computer-readable medium is provided that when executed by a computer may cause the computer to perform one or more aspects of the method of the present invention.

The foregoing and other objects, features and advantages will be apparent from the following description of aspects of the present invention as illustrated in the accompanying drawings.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 6,823,508 (Inventors: Burkhardt, et al.; issued on Nov. 23, 2004) titled “Automatic computer program customization based on a user information store”; U.S. Pat. No. 7,062,645 (Kroening, J.; issued on Jun. 13, 2006) titled “Build to order” personal computer manufacturing fast boot method”; U.S. Pat. No. 6,892,305 (Inventors: Dayan, et al.; issued on May 10, 2005) titled “Method and system for booting up a computer system in a secure fashion”; U.S. Pat. No. 6,523,112 (Inventors: Gallagher, et al.; issued on Feb. 18, 2003) titled “Operating system software boot program execution method”; U.S. Pat. No. 6,993,647 (Inventors: Loh, et al.; issued on Jan. 31, 2006) titled “Method and apparatus for booting an electronic device using a plurality of agent records and agent codes”; and U.S. Pat. No. 7,082,509 (Inventors: Zimmer, et al.; issued on Jul. 25, 2006) titled “Method and system for allocating memory during system boot to reduce operating system memory resource consumption at run-time”; United States Patent Application Publication Ser. No. 20080077873 (Peterson, Harold Lee; published Mar. 27, 2008) entitled “Apparatus, method and computer-readable medium for organizing the display of visual icons associated with information technology processes”; and U.S. patent application Ser. No. 09/423,025 (Peterson, H. L., et al.; filed on Oct. 28, 1999) entitled “Digital content vending, delivery and maintenance system” are each incorporated herein by reference in their entirety and for all purposes.

All publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 is a software flowchart of one aspect of the method of the method of the present invention, wherein application software is launched as a consequence of a booy-up sequence of a computer;

FIG. 2 is a schematic of a start-up table of the method of FIG. 1;

FIG. 3 is a schematic diagram of the computer of FIG. 1;

FIG. 4 is a schematic diagram of software of the computer of FIGS. 1 and 3;

FIG. 5 is a software flowchart of another aspect of the method of the present invention, wherein a series of application software are launched by the computer of FIGS. 1 and 3, wherein each application is fully or substantially launched before a following sequential application software is launched;

FIG. 6 is a software flowchart of a still other aspect of the method of the present invention, wherein a series of application software are launched by the computer of FIGS. 1 and 3, wherein the launch process of each application proceeds for a specified time before a following sequential application software is launched;

FIG. 7 is a software flowchart of a yet other aspect of the method of the present invention, wherein the start-up table of FIG. 3 may be modified by a user of the computer of FIGS. 1 and 3;

FIG. 8 is an illustration of a virtual desktop as visually displayed in a boot-up process by the display screen of the computer of FIGS. 1 and 3;

FIG. 9 is a software flowchart of an additional aspect of the method of the present invention, wherein one or more application records of the start-up table of FIG. 2 may be (a.) added to the start-up table, (b.) deleted from the start-up table, or (c.) prohibited from deletion from the start-up table by the computer;

FIG. 10 is a software flowchart of an another additional aspect of the method of the present invention, wherein the computer 2 of FIGS. 1 and 3 establishes a bi-directional communication session via an electronic communications network of of FIG. 3 with a remote server and may download a application software;

FIG. 11 is a software flowchart of a still additional aspect of the method of the present invention, wherein the computer 2 of FIGS. 1 and 3 may download a application software from the network of FIG. 3 upon user permission;

FIG. 12 is a software flowchart of a yet additional aspect of the method of the present invention, wherein the start-up table of FIG. 3 may be modified by a user of the computer of FIGS. 1 and 3 and application software may be deleted from the computer;

FIG. 13 is a software flowchart of a even additional aspect of the method of the present invention, wherein the start-up table of FIG. 3 may be modified by a user of the computer of FIGS. 1 and 3 upon a first boot-up process of an out-of-the-box experience; and

FIG. 14 is schematic diagram of the network of FIG. 3 that includes the computer of FIGS. 1 and 3, a server, a wireless 56, and/or the Internet.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Embodiments of method for allocating memory during pre-boot in a manner that facilitates efficient hand-off to an operation system and computer apparatus for implementing the method are described herein. In the following description, numerous specific details are set forth, such as embodiments pertaining to the EFI framework, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one aspect” or “an aspect” means that a particular feature, structure, or characteristic described in connection with the aspect is included in at least one process or hardware configuration that is in accordance with the method of the present invention. Thus, the appearances of the phrases “in one aspect” or “in an aspect” in various places throughout this specification are not necessarily all referring to the same instantiation of the method of the present invention. Furthermore, each particular aspect of the method of the present invention, may be included in singularity or in combination in any suitable manner in one or more systems or methods.

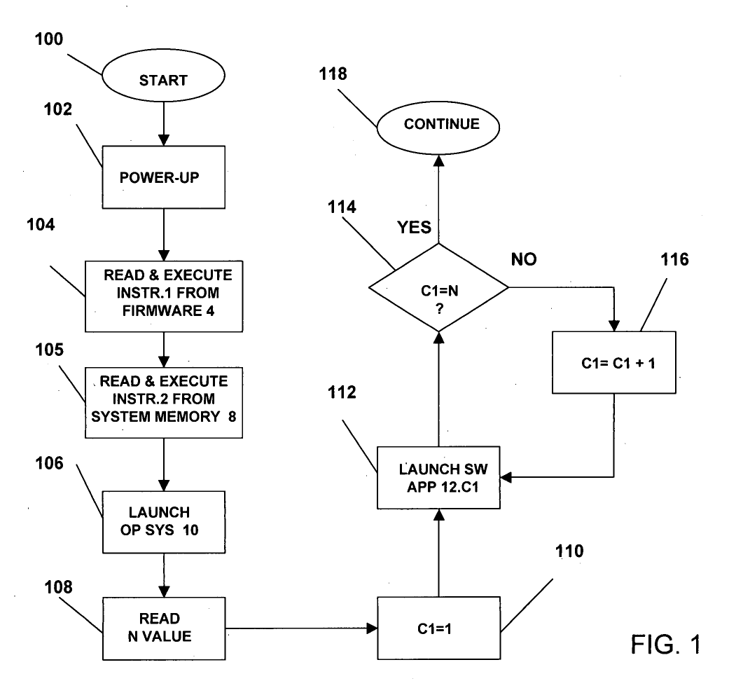

Referring now generally to the Figures and particularly to FIG. 1, FIG. 1 is a software flowchart of one aspect of the method of the method of the present invention. In step 102 a computer 2 powers up in a hardware driven response to a power connection initiated in step 100. A firmware memory 4 of the computer 2 provides an initial boot-up instruction sets INSTR.1 to a central processing unit 6 in step 104, wherein the central processing unit 6 (or “CPU” 6) reads and executes the initial boot-up instruction set INSTR.1 as provided by, or read from, the firmware memory 4 to initiate a launch of an operating system 10 in step 106. In optional step 105 the CPU 6 reads and executes an additional information INSTR.2 read from the system memory 8 to further support the launch of the operating system 10 of step 106.

The operating system 10 is a software program that controls the overall operation of the computer system 2 including such tasks as memory allocation, data input receipt, data output distribution, interrupt processing, job scheduling, an launching and running applications programs 12.A-12.Z.

A start-up table 14 stored in the system memory 108 is applied by the operating system 10 in step 108 and through one or more cycles of steps 112 and step 114. In step 108 the CPU 6 reads the count N of the number of applications programs 12.A-12.N referenced in the start-up table 14 that shall be launched during the boot-up process that extends from step 102 through step 112. The CPU 6 sets a value of a first counter C1 to a zero value in step 110.

The CPU 6 launches a first software application 12.A referenced by the start-up table 14 in a first execution of step 112 and then cycles through steps 112, 114 and step 116 until a launch of each software application 12.A-12.N referenced in the start-up table 14 has been initiated. The value of the first counter C1 is compared against the table counter value N and the repetitions of step 112 cease when the value of the first counter C1 is equal to the table counter value N. When the value of the first counter C1 is found in step 114 to be less than the table counter value N, the computer 2 proceeds from step 114 to (a.) to increment the value of the first counter C1 in step 116; and (b.) to initiate a launch of an applications program 12.B-12.N listed in a next sequential position of the start-up table 14.

When the value of the first counter C1 is found in step 114 to be equal to the table counter value N, the computer 2 proceeds from step 114 to step 118 and to perform additional computational operations. It is understood that the launching of the operating system 10 and/or the launching of one or more of the the software applications 12.A-12.N initiated in an execution of step 112 may not be completed by the computer 2 when the step 118 is executed.

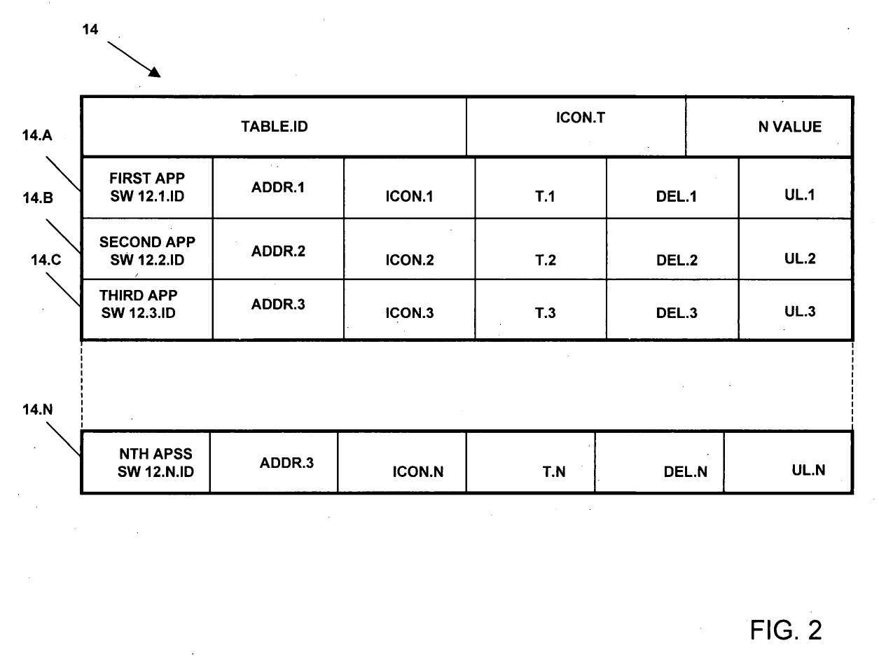

Referring now generally to the Figures and particularly to FIG. 2, FIG. 2 is a schematic of the start-up table 14 in accordance with another aspect of the method of the present invention. The start-up table 14 includes a table identifier TABLE .ID, the table counter N and a plurality of applications records 14.A-14.N. The table icon data includes information useful to the computer 2 in visually presenting a representative table selection icon 15A and a table display 15B of the table 14 on a display screen 16.

An exemplary first application record 14.A includes (a.) a first identifier 12.1.ID that uniquely identifies a first application software 12.1 to the CPU 6; (b.) a first memory address ADDR.1 where a first executable instruction of the first application software 12.1 is stored within the system memory 8; (c.) a first icon data icon.1 that includes information useful to the computer 2 in visually presenting a representative icon of the first application software on a display screen 16; (d.) a first time value T.1 associated with the first application software 12.1; (e.) a first delete permission flag DEL.1 associated with the first application software 12.1; and (f.) a first user permission flag UL.1 associated with the first application software 12.1.

It is understood that each additional application software record 12.2-12.N includes a specified and related (a.) application software identifier 12.2.ID-12.N.ID that uniquely identifies a specific application software 12.2-12.N (or “the identified application software” 12.2-12.N) to the CPU 6; (b.) a specific memory address ADDR.2-ADDR.N where a first executable instruction of the identified application software 12.2-12.N is stored within the system memory 8; (c.) an icon data ICON.2-ICON.N that includes information useful to the computer 2 in visually presenting a representative icon associated with the identified application software 12.2-12.N on the display screen 16; (d.) a time value T.2-T.N associated with the identified application software 12.2-12.N; (e.) a delete permission flag DEL.2-DEL.N associated with the identified application software 12.2-12.N; and (f.) a user permission flag UL.2-UL.N associated with the identified application software 12.2-12.N.

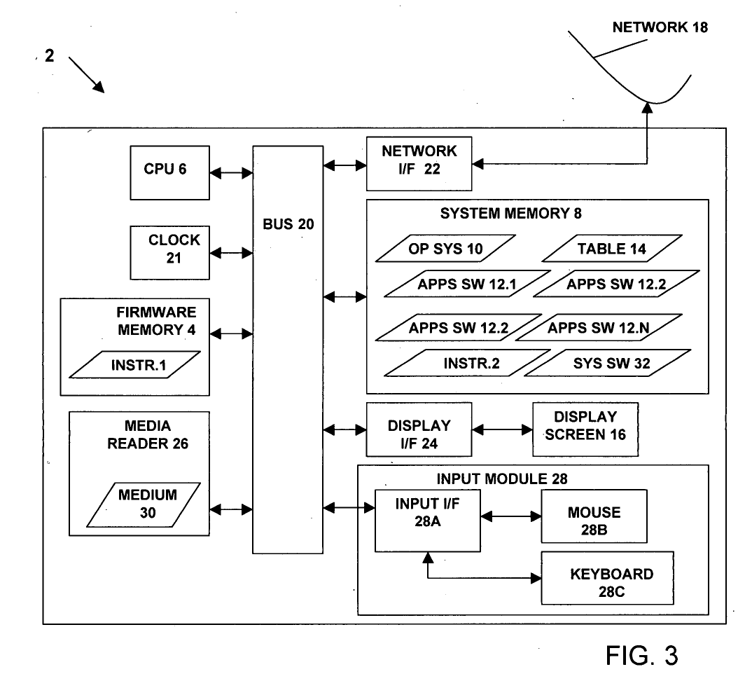

Referring now generally to the Figures and particularly to FIG. 3, FIG. 3 is a schematic of the computer 2 of FIG. 1 in bi-directional communicative coupling with an electronic communications network 18. The computer 2 includes a communications bus 20 that bi-directionally communicatively couples the firmware 4, the CPU 6, the system memory 8, a real time clock 21, a network interface 22, a display interface 24, an electronic media reader 26, and an input module 28. The input module 28 includes an input interface 28A that bi-directionally communicatively couples a computer keyboard 44A and a computer mouse 28BB with the communications bus 20.

The network interface 22 is bi-directionally communicatively coupled with the electronic communications network 18. The input module 28 may be used by a user to transmit the power-up command of step 100 of the method of FIG. 1. The real time clock 21 enables the CPU 6 to determine the passage of time as required in certain alternate aspects of the method of the present invention. The display interface 24 is bi-directionally communicatively coupled with the display screen 16 and is configured to accept icon information ICON.1-ICON.N from the system memory 8 via the communications bus 20 and the display interface 24 and to visually render the icon information ICON.1-ICON.N.

It is understood that the computer 2 may be or comprise an electronic computational device, such as, a VAIO FS8900™ notebook computer marketed by Sony Corporation of America, of New York City, N.Y., an information appliance configured for wireless Internet-enabled communication, a television set-top box, and/or a wireless communications capable communications device, such as (a.) an iPhone™ cellular telephone as marketed by Apple Computer of Cupertino, Calif.; (b.) a wireless communications enabled SUN SPARCSERVER™ computer workstation marketed by Sun Microsystems of Santa Clara, Calif. running LINUX™ or UNIX™ operating system; (c.) a wireless communications enabled personal computer configured for running WINDOWS XP™ or VISTA™ operating system marketed by Microsoft Corporation of Redmond, Wash.; (d.) a PowerBook G4™ personal computer as marketed by Apple Computer of Cupertino, Calif.; (e.); or (f.) a personal digital assistant enabled for wireless communications.

The media writer/reader 26 and the associated computer-readable medium 30are selected and configure to provide non-volatile storage for the computer 2. Although the description of computer-readable media 26 contained herein refers to a mass storage device, such as a hard disk or CD-ROM drive, it should be appreciated by those skilled in the art that computer-readable media can be any available media that can be accessed by the computer 2.

By way of example, and not limitation, the computer-readable medium 30 may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

The computer-readable medium 30 may comprise machine-readable instructions INSTR.1 and/or INSTR.2 in part or in whole which when executed by the computer 2 to cause the computer 2 to perform one or more steps as described in the Figures and enabled by the present disclosure.

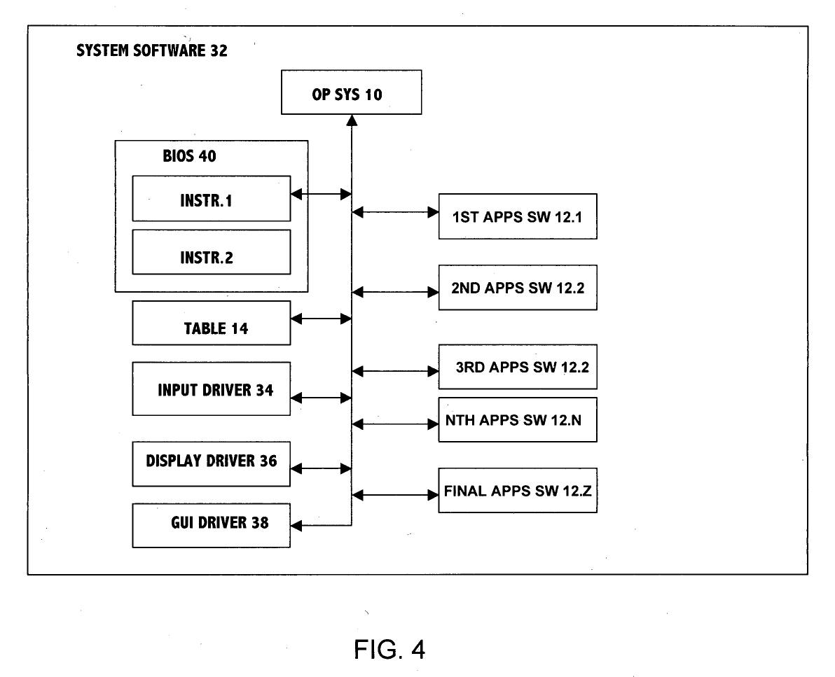

Referring now generally to the Figures and particularly to FIG. 4, FIG. 4 is a schematic diagram of a system software 32 of the computer 2 of FIG. 3. The CPU 6 launches the operating system 10 on the basis of the first boot-up instructions INSTR.1 and/or the second boot-up instructions INSTR.2 as provided by, or read from, the firmware 4, the system memory 8, and/or the computer-readable medium 30. An input driver software 34 accepts instructions and commands generated by the user and received via the input module 28 and delivers the user generated instructions and commands to the CPU 6 via the communications bus 16. A display driver software 36 enables the CPU 6 to direct the display screen 16 to render visual images from data generated by the CPU 6 or sourced from the the firmware 4, the system memory 8, and/or the computer-readable medium 30. A graphic user interface driver software 38 (or “GUI” 38) enables the visual presentation of images on the display screen 16 and the acceptance and interpretation of user selections of the displayed images. The GUI 38 is configured to render a visually render a virtual desktop 40 comprising a table image 42, wherein the table image 42 represents the listing of application software 12.1-12.N referenced in the table 14. The user selections of the displayed images, e.g., icons, visually presented on the display screen 16 may be affected by means of a point and click device, e.g. a computer mouse 28B of the input module 28.

It is understood that the first boot-up instructions INSTR.1 and/or the second boot-up instructions INSTR.2 may be comprised within a basic input-output system 40 (or “BIOS” 40) and that the BIOS 40 may be distributed about the the firmware 4, the system memory 8, and/or the computer-readable medium 30 in various alternate suitable configurations of the computer 2.

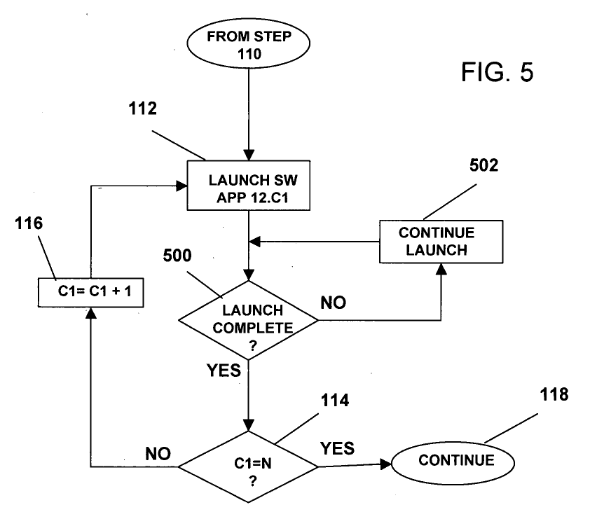

Referring now generally to the Figures and particularly to FIG. 5, FIG. 5 is a software flowchart of a still other aspect of the method of the method of the present invention. In the method of FIG. 5, the alternate steps 500 and 502 direct the computer 2 to fully launch an application software 12.C1 selected in step 112. The computer 2 determines in step 500 whether the application software 12.C1 selected in the most recent execution of step 112 has been fully launched. When the computer 2 determines in step 500 that the application software 12.C1 selected in the most recent execution of step 112 has not been fully launched, the computer 2 proceeds on to step 502 to continue the launch process initiated in the most recent execution of step 112. When the computer 2 determines in step 500 that the application software 12.C1 selected in the most recent execution of step 112 has been fully launched, the computer 2 proceeds from step 500 to step 114.

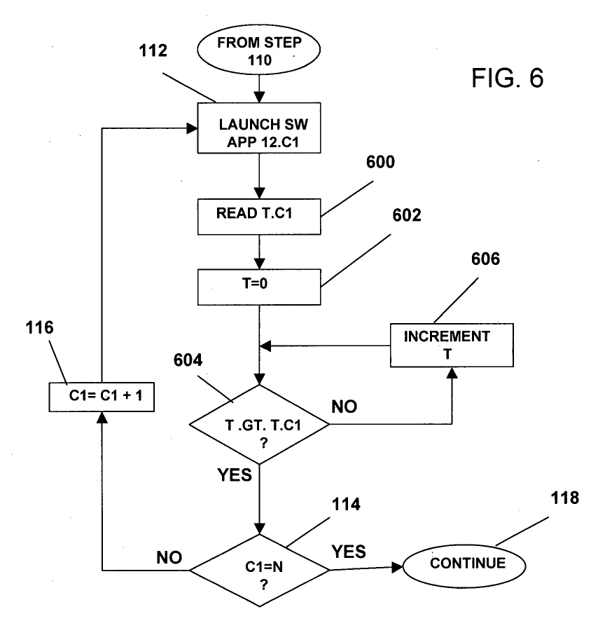

Referring now generally to the Figures and particularly to FIG. 6, FIG. 6 is a software flowchart of a yet other aspect of the method of the method of the present invention. In the method of FIG. 6, the alternate steps 600 through 606 direct the computer 2 to delay initiate a launch of another application software 12.1-12.N until a predesignated time T.C1 has passed since the initiation of launching the application software 12.C1 selected in the most recent execution of step 112.

A time constant T.C1 is read in step 600, wherein the selected time constant T.C1 is read from the same application software record 14.C1 associated with the the application software 12.C1 selected in the most recent execution of step 112. For example, when the variable C1 is equal to the two in an execution of step 112, a launch of the second applications software 12.2 is initiated, and the second time constant T.2 is read from the second application record 14.B in the next execution of step 600.

In step 602 a time variable T is set to a zero value.

The computer 2 determines in step 604 whether the computer 2 has incremented the time variable T to a value greater than the time constant T.C1 read in the most recent execution of step 600. When the computer 2 determines in step 604 that the CPU 6 has not incremented the time variable T to a value greater than the time constant T.C1, the computer 2 proceeds from step 604 to step 606 and to increment the time variable T on the basis of clock pulses received from the real time clock 21. The computer 2 proceeds from step 606 to execute an additional step 604. When the computer 2 determines in step 604 that the computer 2 has incremented the time variable T to a value greater than the time constant T.C1, the computer 2 proceeds from step 604 to step 114 of the method of FIG. 1.

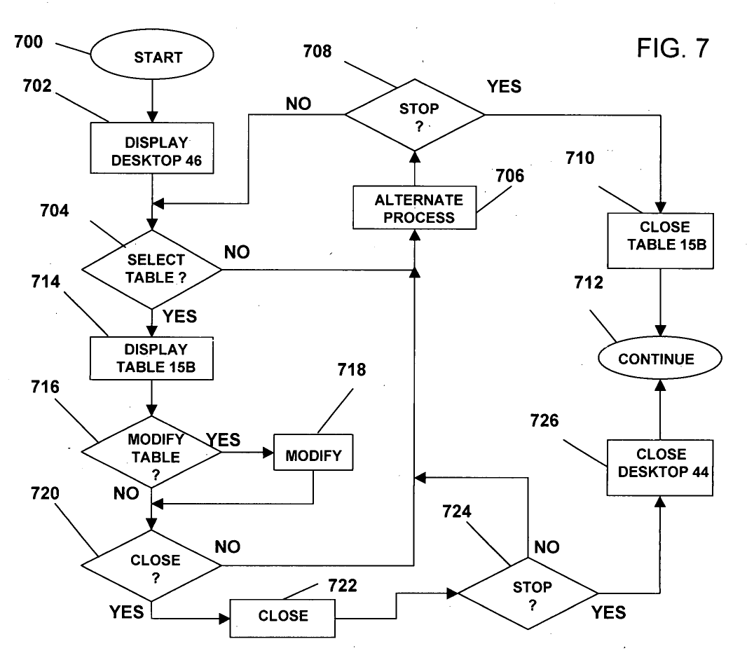

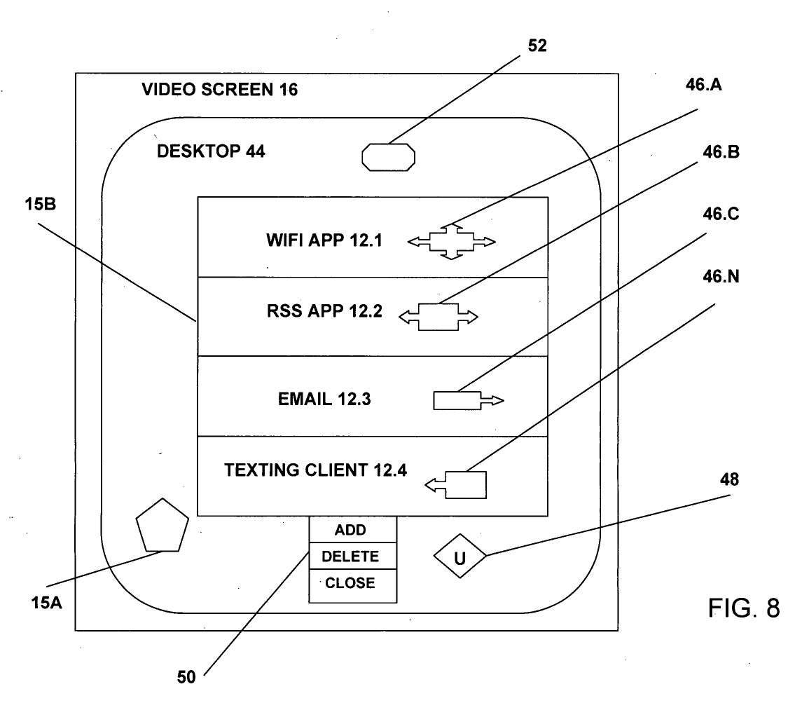

Referring now generally to the Figures and particularly to FIG. 7 and FIG. 8, FIG. 7 is a software flowchart of an even other aspect of the method of the method of the present invention and FIG. 8 is an illustration of a virtual desktop 44 as visually displayed in the boot-up process by the display screen 16. In step 700 the boot-up process is initiated and in step 702 the virtual desktop 44 is rendered by the GUI 38 on the display screen 16. The visual desktop 44 includes a rendering of the table selection icon 15A.

In step 704 the computer 2 determines whether the user has selected the table selection icon 15A by means of the computer mouse 28B. When the computer 2 determines that the user has not selected the table selection icon 15A in step 704, the computer 2 proceeds from step step 704 to step 706 and to perform alternate computational processes. The computer 2 proceeds from step 706 to step 708 and to determine in step 708 whether the computer 2 shall continue to render the virtual desktop 46. When the computer 2 determines in step 708 to cease rendering the virtual desktop 46, the computer 2 proceeds from step 708 to step 710 and ceases rendering the virtual desktop 44 and then proceeds to step 712 and to perform alternate computational processing.

When the computer 2 determines in step 708 to continue rendering the virtual desktop 46, the computer 2 proceeds from step 708 to step 704. When the computer 2 determines that the user has selected the table selection icon 15A in step 704, the GUI 38 renders the table icon 15B as derived from the table icon data ICON.T of the table 14 in step 714.

The computer 2 determines in step 716 whether the user has selected the table icon 14B for modification by generating signals from the input module 28. When the computer 2 determines in step 716 that the user has selected the table icon 14B for modification, the computer 2 proceeds from step 716 to step 718 and to add or delete application records 14.A-14.N to or from the table 14 as directed by signals generated from the input module 28 by the user.

When the computer 2 determines in step 716 that the user has not selected the table icon 15A for modification, the computer 2 proceeds from step 716 to step 720 and to determine whether to continue rendering the table icon 15B as directed by instructions received from the input module 28. When the computer 2 receives instructions from the input module 28 in step 720 to cease rendering the table icon 15B, the computer 2 proceeds from step 720 to step 722 wherein the GUI 38 ceases rendering the table icon 15B. The computer 2 proceeds from step 722 to step 724 and to cease rendering the virtual desktop 44 on the display screen 16. When the computer 2 receives instructions from the input module 28 in step 720 to cease rendering the desktop 44 in step 724, the computer 2 proceeds from step 724 to step 726 wherein the GUI 38 ceases rendering the desktop 38 in step 726, and the computer 2 proceeds from step 726 to step 712 and to perform alternate computational operations.

When the computer 2 has not received instructions from the input module 28 in step 720 to cease rendering the table icon 15B, the GUI 38 continues to render the table icon 15B and the computer 2 proceeds from step 720 to step 706.

Referring now generally to the Figures and particularly to FIG. 8, FIG. 8 is an illustration of a virtual desktop 44 as visually displayed by the display screen 16 as a consequence of the boot-up process. The table icon 15B includes application software icons 46.A-46.N that are derived by the GUI 38 from the icon data ICON.1-ICON.N of the table 14. It is understood that one or more application software icons 46.A-46.N may include a representation of identifying signage and text, e.g., trademark designs, text and product names.

A position of a cursor 48 generated by the GUI 38 within the desktop 44 is controlled by the user by means of manipulating the mouse 28B and/or the keyboard 28A. The user may further direct the GUI 38, by means of commands issued from the mouse 28B and/or the keyboard 28A, to instantiate a table drop down command menu 50 whereby the computer 2 may be directed to (a.) delete a selected application software icons 46.A-46.N, (b.) add a new application software icon to the table icon 15B, or (c.) to close the table icon 15B. It is understood that the deletion of an application software icon 46.A-46.N may be affected by deleting a corresponding application record 14.A-14.N from the table 14. It is further understood that the addition of an additional application software icon 52 may be affected by adding a corresponding application record 14.A-14.N to the table 14. The computer 2 may be directed to add an application record 14.A-14.N to the table by using the mouse 28B to drag and drop an additional application software icon 52 onto the table icon 15B.

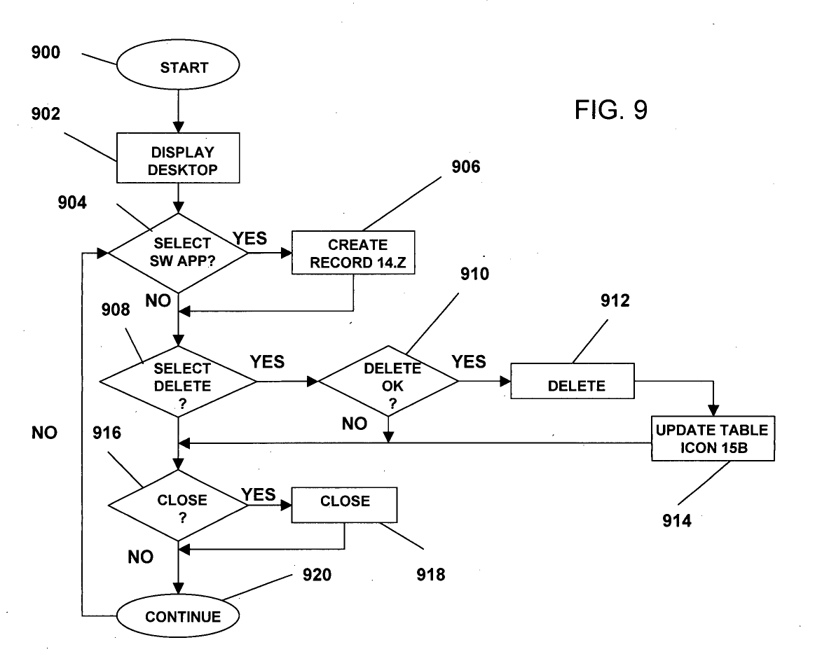

Referring now generally to the Figures and particularly to FIG. 9, FIG. 9 is a software flowchart of an additional aspect of the method of the present invention, where one or more application records 14.A-14.N may be (a.) added to the table 14, (b.) deleted from the table 14, or (c.) prohibited from deletion from the table 14 by the computer 2. In step 900 the boot-up process is initiated and in step 902 the virtual desktop 44 is rendered by the GUI 38 on the display screen 16.

In step 904 the computer 2 determines whether the user has selected, by means of the computer mouse 28B and/or the keyboard 28A, an application software 12.Z for inclusion by reference within the table 14. When the computer 2 determines that the user has selected an application software 12.Z in step 904 for inclusion by reference within the table 14, the computer 2 proceeds from step 904 to step 906 and to (a.) form a new application record 14.Z, (b.) add the new application record 14.Z into the table 14, and (c.) increment the value of the table counter N of the table 14. When the computer 2 does not detect a user selection of an application software 12.Z in step 904, the computer 2 proceeds from step 904 to step 908.

In step 908 the computer 2 determines whether the user has selected an application record 14.A-14.B for deletion from the table 14 by means of the computer mouse 28B and/or the keyboard 28A. When the computer 2 determines that the user has selected an application record 14.A-14.N for deletion from the table 14 in step 908 by means of generating commands from and instructions by means of the computer mouse 28B and/or the keyboard 28A, the computer 2 proceeds from step 908 to step 910 to determine whether a delete permission flag DEL.1-DEL.N of the application record 14.A-14.N is set to prohibit or to allow the requested deletion of step 908. When the computer 2 determines in step 910 that the delete permission flag DEL.1-DEL.N of the application record 14.A-14.N selected in step 908 is set at a permission value to permit the selected application record 14.A-14.N to be deleted from the table 14, the computer 2 proceeds onto step 912 and to delete the application record 14.A-14.N selected in step 908 from the table 14 and to decrement the value of the table counter N of the table 14. The computer 2 proceeds from step 912 to step 914 wherein the GUI 38 updates a rendering of the table icon 14B to reflect the deletion of step 912.

When the computer 2 determines in step 910 that the delete permission flag DEL.1-DEL.N of the application record 14.A-14.N selected in step 908 is set at a deletion prohibition value, the computer 2 proceeds from step 910 to step 916 and without deleting the application record 14.A-14.N selected in step 908.

The computer 2 determines in step 916 whether the user has directed, via the input module 28, the computer 2 to cease rendering the table icon 14. When the computer 2 determines in step 916 that the user has directed the computer 2 to cease rendering the table icon 14, the computer 2 proceeds from step 916 to step 918 wherein the GUI 38 ceases rendering the table icon 15B. The computer 2 proceeds from step 918 to step 920 and to perform additional computational operations.

When the computer 2 determines in step 916 that the user has not directed the computer 2 to cease rendering the table icon 15B, the computer 2 proceeds from step 916 to step 920 and to perform additional computational operations.

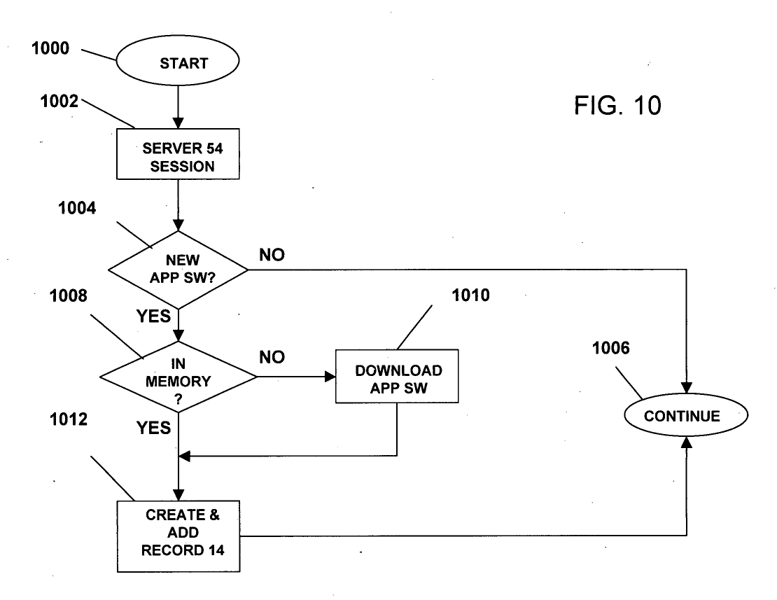

Referring now generally to the Figures and particularly to FIG. 10, FIG. 10 is a software flowchart of another additional aspect of the method of the present invention. In step 1002 the computer 2 establishes a bi-direction communication session via the electronic communications network 18 (hereinafter “the network” 18) with a server 54. In step 1004 the computer 2 determines whether the server 54 is directing the computer 2 to add an application record 14.A-14.N to the table 14. When the computer 1004 determines in step 1004 that the server 54 is not directing the computer 2 to add an application record 14.A-14.N to the table 14, the computer 2 proceeds from step 1006 and to perform alternate computational operations.

When the computer 2 determines in step 1004 that the server 54 is directing the computer 2 to add an application record 14.A-14.N to the table 14, the computer 2 proceeds to step 1108 and to determine whether the application software 12.1-12.Z identified in step 1004 is resident in the computer 2, e.g., available from the system memory 8, the firmware memory 4, and/or the computer-readable medium 30. When the computer 2 determines in step 1008 that the application software 12.1-12.Z identified in step 1004 is not resident in the computer 2, the computer 2 downloads the identified application software 12.1-12.Z in step 1010 from the network 2.

The computer 2 proceeds from either step 1008 or step 1010 to step 1012 to create a new application record 14.A-14.N, to add the newly created application record 14.A-14.N, and to increment the value of the table counter N of the table 14. The computer 2 proceeds from step 1012 to step 1006 and to perform additional computational operations.

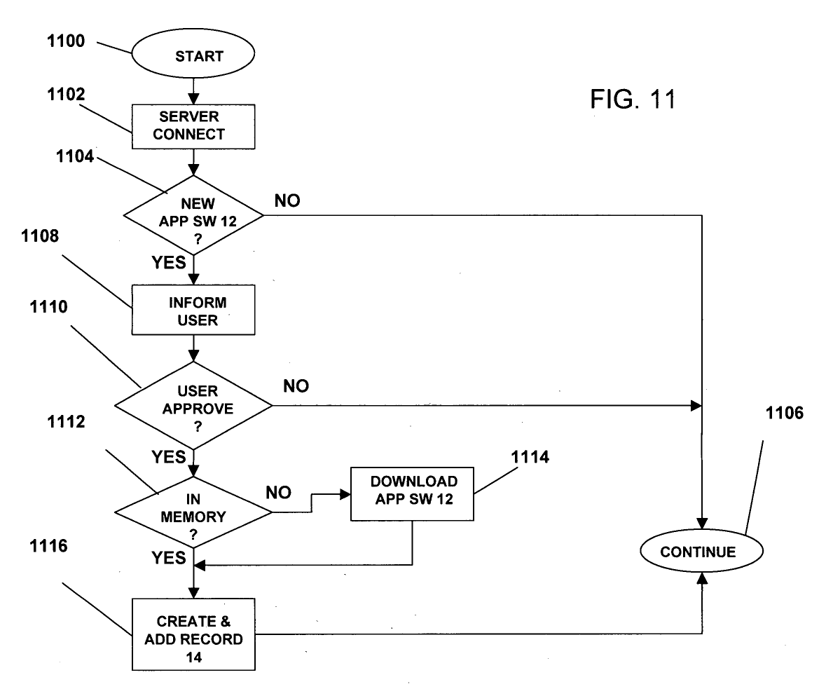

Referring now generally to the Figures and particularly to FIG. 11, FIG. 11 is a software flowchart of a still additional aspect of the method of the present invention. In step 1102 the computer 2 establishes a bi-direction communication session via the electronic communications network 18 (hereinafter “the network” 18) with a server 54. In step 1104 the computer 2 determines whether the server 54 is directing the computer 2 to add an application record 14.A-14.N to the table 14. When the computer 1104 determines in step 1104 that the server 54 is not directing the computer 2 to add an application record 14.A-14.N to the table 14, the computer 2 proceeds from step 1106 and to perform alternate computational operations.

When the computer 2 determines in step 1104 that the server 54 is directing the computer 2 to add an application record 14.A-14.N to the table 14, the computer proceeds to step 1108 and to inform the user via the display screen 16 that a request has been received to add a reference to an additional application software 12.Z to the table 14. The computer 2 proceeds from step 1108 to step 1110 to determine whether the user has approved, by means of the computer mouse 28B and/or the keyboard 28A, an inclusion by reference of the application software 12.Z identified in step 1108 within the table 14. When the computer 2 determines in step 1110 not to have received a user approval an inclusion by reference of the application software 12.Z identified in step 1108 within the table 14, the user proceeds from step 1110 to step 1106 and to perform additional computational processes.

It is understood that the computer 2 may be programmed to, when a user permission flag UL.1-UL.1N of an application record 114.1-14.N is set to a permission state, direct the computer 2 to generate a new application record 14.1-14.N new application software of step 1104 and without requiring an explicit permission of the user as required by step 1110, wherein the computer 2 will proceed from step 1104 directly to step 1112.

When the computer 2 determines in step 1110 to have received a user approval an inclusion by reference of the application software 12.Z identified in step 1108 within the table 14, the user proceeds from step 1110 to step 1112.

The computer 2 determines in step 1112 whether the application software 12.1-12.Z identified in step 1108 is resident in the computer 2, e.g., available from the system memory 8, the firmware memory 4, and/or the computer-readable medium 30. When the computer 2 determines in step 1112 that the application software 12.1-12.Z identified in step 1108 is not resident in the computer 2, the computer 2 downloads the identified application software 12.1-12.Z in step 1114 via the network 2.

The computer 2 proceeds from either step 1112 or step 1114 to step 1116 to (a.) create a new application record 14.A-14.N, (b.) to add the newly created application record 14.A-14.N, and (c.) to increment the value of the table counter N of the table 14. The computer 2 proceeds from step 1116 to step 1106 and to perform additional computational operations.

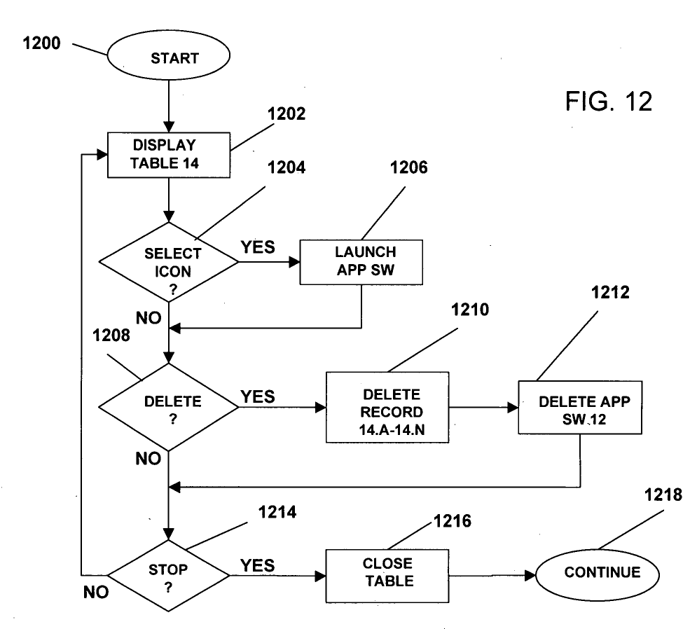

Referring now generally to the Figures and particularly to FIG. 12, FIG. 12 is a software flowchart of a yet additional aspect of the method of the present invention. In step 1200 the boot-up start is initiated and in step 1202 the table 14 by the GUI 38 on the display screen 16 is rendered as a consequence as of the boot-up initiation of step 1200. In step 1204 the computer 2 determines whether the input module 28 has issued an instruction to launch an application software 12.1-12.N referenced within the table 14, wherein the launch instruction is communicated by the user to the computer 2 by a selection of an application software icon 46.A-46.N from the table icon 15N by means of the keyboard 28A or the mouse 28B.

When the computer 2 determines in step 1204 the input module 28 has issued an instruction to launch an application software 12.1-12.N referenced within the table 14, the computer 2 proceeds to step 1206 to launch the application software 12.1-12.N as selected in step 1204.

The computer 2 proceeds from step 1204 or step 1206 to step 1208, wherein the user has the option to delete one or all of the application records 14.A-14.N from the table 14 prior to a first launch of any application software 12.1-12.N as an automated consequence of the boot-up initiation of step 1200. In other words, the process of steps 1208 through 1212 enable a user to delete an application record 14.A-14.N prior to a single, a first, or a succeeding launch of a software application 12.1-12.N referenced by the deleted application record 14.A-14.N.

In step 1208 the computer 2 determines whether the input module 28 has issued an instruction to delete one or more application records 14.A-14.N from the table 14, wherein the deletion instruction is communicated by the user to the computer 2 by means of the keyboard 28A or the mouse 28B. Application records 14.A-14.N noted for deletion in step 1208 are deleted from the table 14 in step 1210, and in optional step 1212 one or more application software 12.1-12.N referenced in the deleted application record(s) of step 1210 may be deleted from the computer 2.

The computer 2 proceeds from step 1208 or step 1212 to step 1214 and to determine whether the input module 28 has issued an instruction to cease rendering the table icon 15B. When the computer 2 determines in step 1214 that the input module 28 has issued an instruction to cease rendering the table icon 15B, the computer 2 proceeds from step 1214 to step 1216 wherein the GUI 38 ceases rendering the table icon 15B. The computer proceeds from step 1216 to step 1218 and to perform additional computational processing.

When the computer 2 determines in step 1214 to not have received an instruction to cease rendering the table icon 15B, the computer 2 proceeds from step 1214 to step 1202.

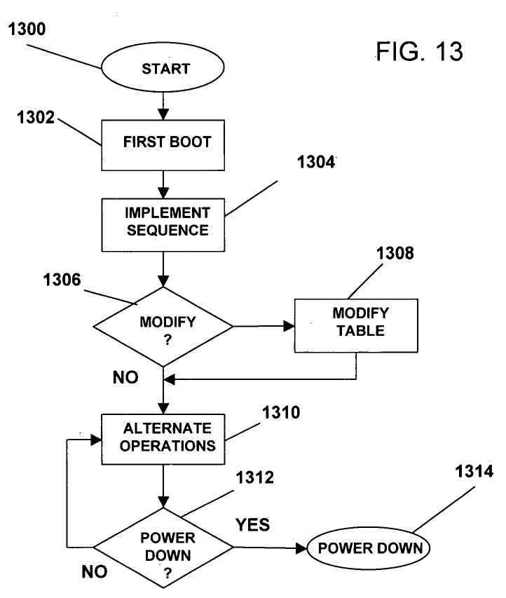

Referring now generally to the Figures and particularly to FIG. 13, FIG. 13 is a software flowchart of an even additional aspect of the method of the present invention. In step 1300 the computer 2 is provided with electrical power and an automated first boot-up process begins in step 1302, wherein the first boot-up process of step 1302 occurs as an out-of-the box experience of the user of the computer 2. In step 1304 a launch sequence is implemented by launching the application software 12.1-12.N referenced in the table 14 as included in the table 14 prior to the first boot process of step 1302. In step 1306 the user may modify the table 14 by adding or deleting one or more application records 14.A-14.N from the table 14. The computer 12 proceeds from either step 1306 or step 1408 to step 1310 and to perform alternate computational operations. The user has the option in step 1312 to direct the computer 2 to power down by proceeding to step 1314 to power down, or to return to step 1310 and to perform additional computational operations.

The computer 2 will execute step 1304 in a following boot-up process by launching the application software 12.1-12.N referenced by the table 14 as modified in the most recent execution of step 1308.

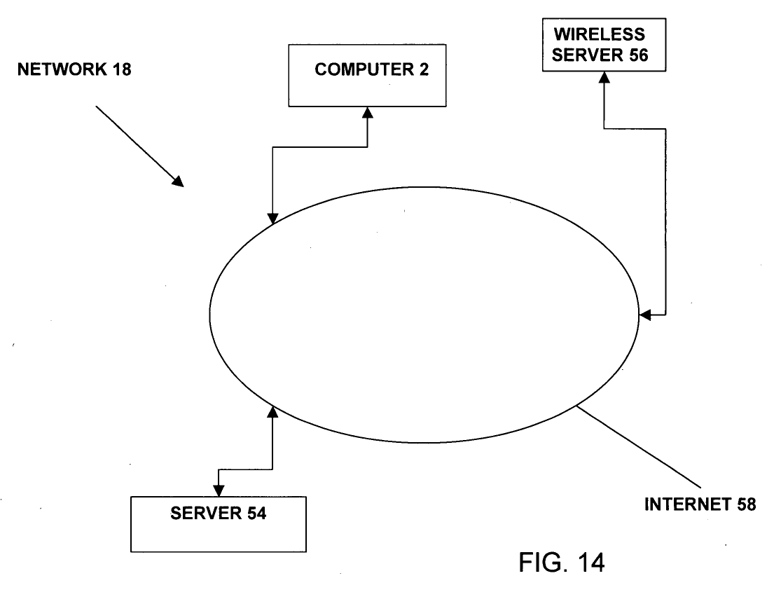

Referring now generally to the Figures and particularly to FIG. 14, FIG. 14 is schematic diagram of the network 18 that includes the computer 2, the server 54, a wireless 56, and/or the Internet 58. The server 54 and/or the wireless server 56 may be or comprise one or all of the elements 1-16, 20-30, and/or aspects of the computer 2 as described within this disclosure. In addition and more particularly, the server 54 and/or and one or more wireless servers 56 may be or comprise, alone or in combination, (a.) a SUN SPARCSERVER™ computer workstation marketed by Sun Microsystems of Santa Clara, Calif. running LINUX™ or UNIX™ operating system; (b.) a server or personal computer configured for running WINDOWS XP™ or VISTA™ operating system marketed by Microsoft Corporation of Redmond, Wash.; (c.) a PowerBook G4™ personal computer as marketed by Apple Computer of Cupertino, Calif.; (d.) an information appliance configured for Internet-enabled communication; and (e.) a wireless communications-enabled communications device.

It is understood that the computer 2 may be configured to communicate with the network 18, server 54 and/or the Internet 58 by cellular communications means and methods and/or wireless digital communications means and methods. More particularly, in an alternate aspect of the method of the present invention, the computer 2 may be an iPhone™ and the wireless server 56 may be or comprise a wireless transceiver that bi-directionally communicatively couples the iPhone 2 with the network 18.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. In a computer system having a controller, a memory, an operating system and a plurality of applications, a method for sequentially launching the plurality of applications at boot-up, the method comprising:
recording a sequence of launch for the plurality applications within the memory;
receiving a user input to initiate boot-up;
affecting boot-up by the controller as directed by the operating system; and
launching each application in the sequence of launch.

2. The method of claim 1, wherein the controller assures that at least one application is running before initiating a succeeding launch of another application.

3. The method of claim 1, wherein the computer further comprises a real-time clock and the sequence of launch is organized as a timed sequence.

4. The method of claim 1, wherein the boot-up occurs at a first boot-up by a user.

5. The method of claim 1, wherein the sequence of launch is modifiable by the user.

6. The method of claim 5, wherein the sequence of launch is modified prior to a first launch of any application designated within a default sequence of launch.

7. The method of claim 6, wherein the user removes at least one application from the sequence of launch.

8. The method of claim 7, wherein the user deletes the at least one application without a launch of the at least one application by the computer.

9. The method of claim 5, wherein removal from the sequence of launch of at least one alternate application is impeded by the computer.

10. The method of claim 9, wherein the user deletes the at least one alternate application after at least one launch of the at least one alternate application.

11. The method of claim 1, wherein at least one application is launched upon user command.

12. The method of claim 11, wherein at least one application requires a user command to direct the computer to launch the at least one application.

13. The method of claim 1, wherein the user includes a reference to an additional application to the sequence of launch, whereby the additional application is launched upon succeeding boot-ups.

14. The method of claim 13, wherein the computer further comprises a communications interface enabling bi-directional communication with the Internet, and the additional application is downloaded from the Internet.

15. The method of claim 1, wherein the computer further comprises a communications interface enabling bi-directional communication with the Internet, and a remote server provides a reference to an additional application to the sequence of launch, whereby the additional application is launched upon succeeding boot-ups.

16. The method of claim 15, wherein the additional application is downloaded from the Internet.

17. The method of claim 16, wherein the user removes the additional application from the sequence of launch.

18. The method of claim 7, wherein the user deletes the additional application without a launch of the additional application by the computer.

19. A computational system comprising:
means to record a sequence of launch for the plurality applications;
means to receive a user input to initiate a boot-up; and
means to launch each application in the sequence of launch.

20. A computer-readable medium comprising machine-readable instructions which when executed by a computational system cause the computational system to perform a method
comprising:
record a sequence of launch for the plurality applications within the memory; and
launch each application in the sequence of launch.
